(19) United States
(12) Patent Application Publication
(10) Pub. No.: US 2016/0139766 A1
(43) Pub. Date: May 19, 2016

(54) MOBILE TERMINAL AND CONTROLLING METHOD THEREOF

(71) Applicant: LG ELECTRONICS INC., Seoul (KR)

(72) Inventors: Samsick KIM, Seoul (KR); Seojin LEE, Seoul (KR); Donghwan YU, Seoul (KR)

(21) Appl. No.: 14/922,479

(22) Filed: Oct. 26, 2015

(30) Foreign Application Priority Data
Nov. 14, 2014 (KR) 10-2014-0158834

(51) Int. Cl. G06F 3/0488; G06F 3/0481; G06F 17/24; G06F 3/0484; G06F 3/0482

(52) U.S. Cl. CPC G06F 3/0488; G06F 3/04842; G06F 3/0482; G06F 17/24; G06F 3/04817

(57) ABSTRACT

A mobile terminal and controlling method thereof are disclosed, by which facilitating management of contents saved in a clipboard. The present invention includes a touchscreen, a clipboard memory, and a controller configured to control the touchscreen to display a screen associated with a first application, save, in the clipboard memory, content designated by a user displayed on the screen associated with the first application, and control the touchscreen to display the saved content together with a screen associated with a second application, in response to receiving a command to switch from displaying the screen associated with the first application to displaying the screen associated with the second application.

Pursuant to 35 U.S.C. §119(a), this application claims the benefit of earlier filing date and right of priority to Korean Application No. 10-2014-0158834, filed on Nov. 14, 2014, the contents of which are hereby incorporated by reference herein in their entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for facilitating the use of a terminal in further consideration of user's convenience.

2. Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Generally, a mobile terminal provided in form of such a smartphone is provided in a manner of outputting a desired data through a screen of a relatively wide touchscreen and receiving a control input through the outputted screen. However, regarding a method of controlling a considerable quantity of various contents through the touchscreen, efficient control methods have not been provided yet. Specifically, the demand for a control method for effectively performing a copy & paste operation on various kinds of contents is increasingly rising.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide a mobile terminal and controlling method thereof, by which various kinds of contents can be effectively copied & pasted.

Technical tasks obtainable from the present invention are non-limited by the above-mentioned technical tasks. And, other unmentioned technical tasks can be clearly understood from the following description by those having ordinary skill in the technical field to which the present invention pertains.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to one embodiment of the present invention may include a touchscreen, a clipboard memory, and a controller configured to control the touchscreen to display a screen associated with a first application, save, in the clipboard memory, content designated by a user displayed on the screen associated with the first application, and control the touchscreen to display the saved content together with a screen associated with a second application, in response to receiving a command to switch from displaying the screen associated with the first application to displaying the screen associated with the second application.

In another aspect of the present invention, as embodied and broadly described herein, a method of controlling a mobile terminal that includes a touchscreen according to another embodiment of the present invention may include the steps of displaying a screen associated with a first application, saving in a clipboard memory, content designated by a user displayed on the screen in a clipboard memory, and displaying the saved first content together with a screen associated with second application, in response to receiving a command to switch from displaying the screen associated with the first application to displaying the screen associated with the second application.

Accordingly, embodiments of the present invention provide various effects and/or features.

According to at least one of embodiments of the present invention, contents provided using a mobile terminal can be easily managed.

According to at least one of embodiments of the present invention, in inputting text data, editing can be further facilitated.

Effects obtainable from the present invention may be non-limited by the above mentioned effect. And, other unmentioned effects can be clearly understood from the following description by those having ordinary skill in the technical field to which the present invention pertains. It is to be understood that both the foregoing general description and the following detailed description of the present invention are exemplary and explanatory and are intended to provide further explanation of the invention as claimed.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure;

FIGS. 1B and 1C are conceptual views of one example of the mobile terminal, viewed from different directions;

FIG. 2 is a flowchart of a control method for easily calling a clipboard having a prescribed content saved therein according to one embodiment of the present invention;

FIG. 3 is a diagram for a control method of copying a content outputted to a touchscreen 151 according to one embodiment of the present invention;

FIG. 4 is a diagram for a control method of easily calling a clipboard region on a running screen of a message transceiving application according to one embodiment of the present invention;

FIG. 5 is a diagram for a control method of calling a clipboard region in case of absence of an input to a text input window 400 for a prescribed time according to one embodiment of the present invention;

FIG. 6 is a diagram for a control method of inputting a clipboard content 302 to a text input window 400 according to one embodiment of the present invention;

FIG. 7 is a diagram for a control method of calling a clipboard content saved in a clipboard memory according to one embodiment of the present invention;

FIG. 8 is a diagram for a control method of outputting a clipboard content if receiving a command for outputting an application list according to one embodiment of the present invention;

FIG. 9 is a diagram for a control method of inputting an outputted clipboard content to an application outputted through an application list according to one embodiment of the present invention;

FIG. 10 is a diagram for a control method of inputting a clipboard content to a most recently run application according to one embodiment of the present invention;

FIG. 11 is a diagram for a control method of managing an extended content using a clipboard according to one embodiment of the present invention;

FIG. 12 is a diagram for a control method of copying a plurality of content items collectively and then saving the copied items according to one embodiment of the present invention;

FIG. 13 is a diagram for a control method of collectively saving an image content and a URL (uniform resource locator) content together with a text content according to one embodiment of the present invention;

FIG. 14 is a diagram for a control method for a case that the above-mentioned hyperlink text is selected of according to one embodiment of the present invention;

FIG. 15 is a diagram for a control method of distinguishing a scheme for inputting a complex content according to one embodiment of the present invention;

FIG. 16 is a diagram for a control method of when a plurality of contents are saved in a clipboard memory, if an unused content exists, controlling an output of a clipboard region 70 to be maintained instead of disappearing according to one embodiment of the present invention;

FIG. 17 is a diagram for a control method of determining an information difficult to be memorized by a user and then saving the corresponding information automatically without a user's command according to one embodiment of the present invention;

FIG. 18 is a diagram for a control method of efficiently deleting and managing a content saved in a clipboard memory according to one embodiment of the present invention;

FIG. 19 is a diagram for a control method of easily editing a previously inputted text data according to one embodiment of the present invention;

FIGS. 20 to 22 are diagrams for a control method of designating a portion of a text inputted by a user according to one embodiment of the present invention; and

FIGS. 23 to 25 are diagrams for a control method of distinguishing an undo/redo command according to one embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

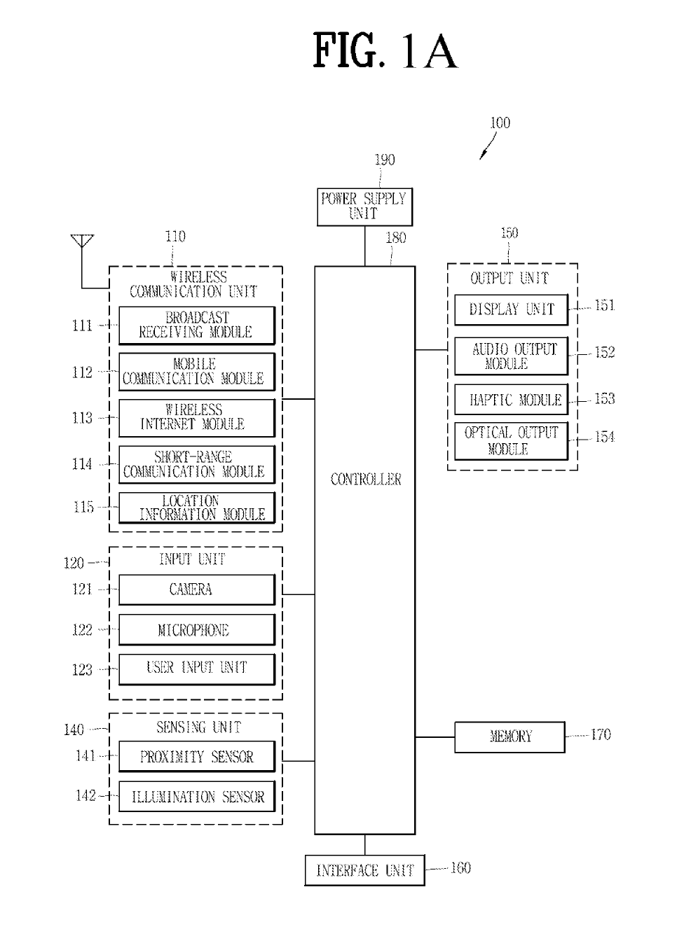

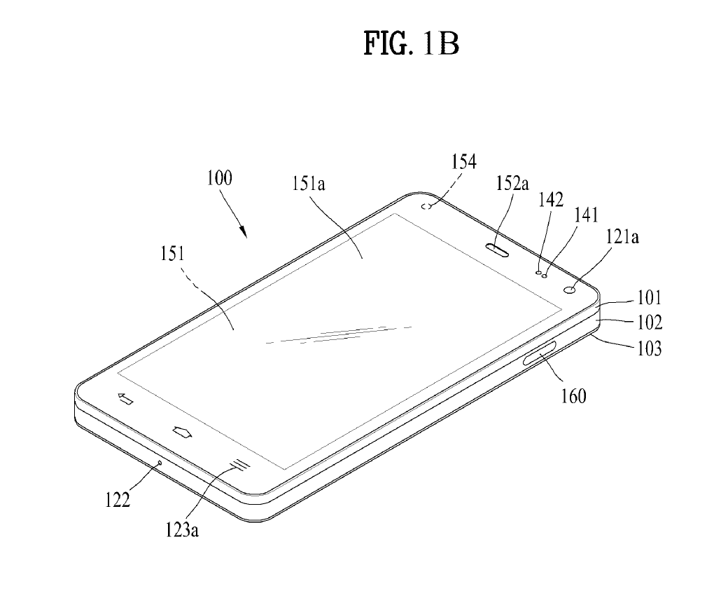

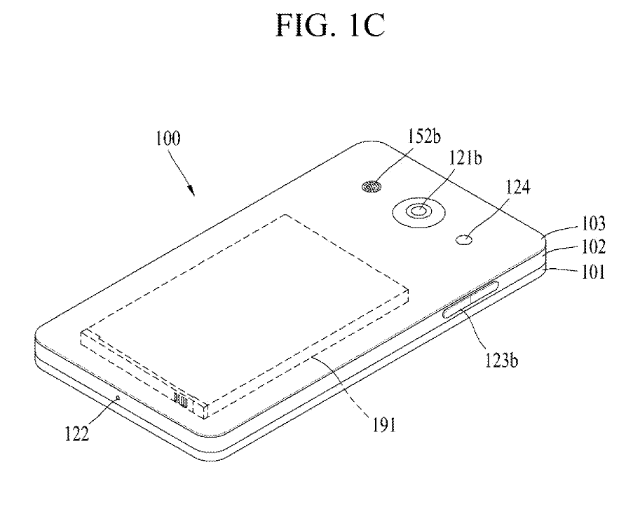

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, informations and the like inputted or outputted through the above-mentioned components and/or runs application programs saved in the memory 170, thereby processing or providing a user with appropriate informations and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the first audio output unit 152a, the second audio output unit 152b, the proximity sensor 141, the illumination sensor 142, the optical output unit 154, the first camera 121a, the second camera 121b, the first manipulating unit 123a, the second manipulating unit 123b, the microphone 122, the interface unit 160, and the like.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

In the following description, control methods, which can be implemented in the above-configured mobile terminal, according to embodiments of the present invention are explained with reference to the accompanying drawings. It will be appreciated by those skilled in the art that various modifications and variations can be made in the present invention without departing from the spirit or scope of the inventions.

As mentioned in the foregoing description, since the performance of the mobile terminal 100 has made rapid progress recently, contents of various types handled by fixed terminals can be processed by the mobile terminal 100 as well. In this case, the types of the contents may include a text content, a video content, a voice content, a location (or position) information content, an image content, a contact content and the like.

The present invention intends to propose a controlling method for enhancing convenience in a mobile terminal environment that handles contents of various types. In particular, the present invention intends to propose a method of facilitating a control of an operation of copying & pasting a specific content and a controlling method for adaptively performing such an operation in accordance with an environment for performing the corresponding operation.

Meanwhile, in the following descriptions of embodiments of the present invention, a terminology ‘copy & paste operation’ is used. A user may attempt to use a specific content, which is currently used in a prescribed application (or a specific use environment), in a specific application (or another use environment). In this case, the user temporarily saves the corresponding specific content and is then able to input the specific content in a manner that the specific content is brought by a different application. For this operation, if an input for saving a specific content is received from a user, the controller 180 saves the corresponding specific content in the memory 160. Such an operation is named a copy operation. In the above description of the copy operation, a specific content is saved temporarily for example. Alternatively, a method of saving a specific content in a non-flash memory permanently can be included as well as a method of saving a specific content in a flash memory temporarily.

The content saved in the above manner can be inputted in a manner of being brought by a user's input in a different application (or a different use environment). Such an operation is named a paste operation. In particular, the paste operation means an operation performed in a manner that the controller 180 reads in a specific content saved in the memory 160 and then inputs the corresponding content.

First of all, the above-mentioned copy operation and a clipboard corresponding to a tool for editing & managing copied contents are described as follows.

Clipboard is a tool for managing at least one content saved by a copy operation. And, the clipboard may include one virtual region for outputting a list of at least one or more contents saved in the memory 160 to the touchscreen. In the following description, although such an expression of saving something in a clipboard, the controller 180 can control something to be saved in the memory 160 actually. Yet, the expression of saving a specific content in a clipboard may be interpreted as controlling the specific content to be included in a content list displayed on the clipboard.

Embodiments of the present invention mentioned in the following description relate to a control method of facilitating a copy to a clipboard and a control method of easily calling a content saved in a clipboard.

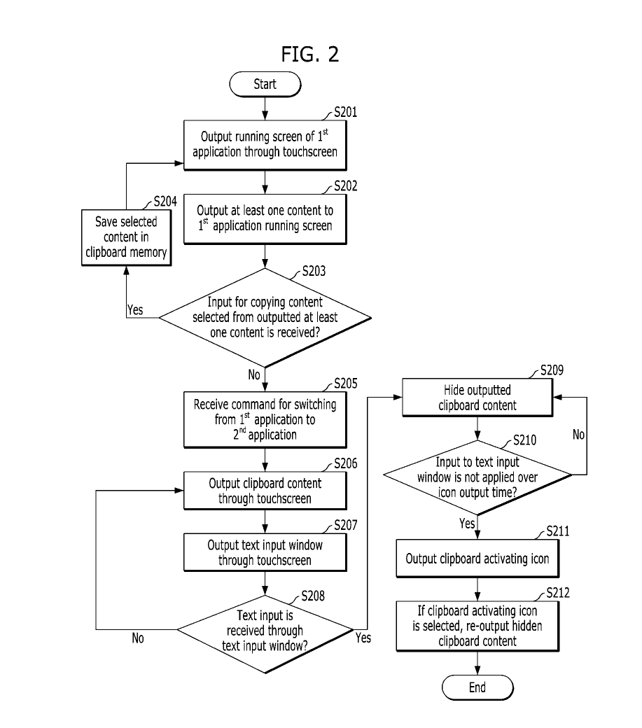

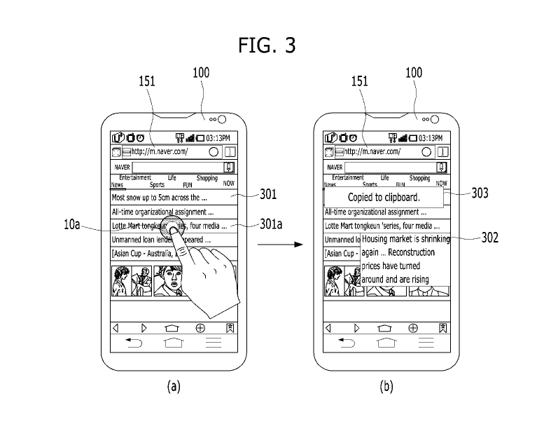

FIG. 2 is a flowchart of a control method for easily calling a clipboard having a prescribed content saved therein according to one embodiment of the present invention. The flowchart shown in FIG. 2 is described in detail with reference to the state diagrams shown in FIGS. 3 to 7 as follows.

FIG. 3 is a diagram for a control method of copying a content outputted to a touchscreen 151 according to one embodiment of the present invention.

The controller 180 can control the touchscreen 151 to display a screen associated with a first application (i.e., a web browser application).

Referring to FIG. 3 (a), a running screen of a web browser application is currently outputted [S201]. The running screen of the application can output at least one content [S202]. According to the example shown in FIG. 3 (a), a news content list 301 is outputted.

If an input 10a for copying a specific content contained in the new content list 301 is received [S203], the controller 180 can save the specific content in a clipboard memory [S204]. In other words, the controller 180 can save, in the clipboard memory, content designated by a user displayed on the screen associated with the first application. In this case, the clipboard memory may include a physical storage space as a storage space for managing a clipboard or may mean a virtual storage space. Hence, according to one embodiment of the present invention, an operation for saving in a clipboard memory may be interpreted as an operation of saving in the memory 170 to enable such a management as an editing/copying operation through a clipboard.

After the controller 180 has saved the specific content in the clipboard memory, referring to FIG. 3 (b), the controller 180 may output a guide popup window 303 indicating that the specific content has been saved. Moreover, according to one embodiment of the present invention, the controller 180 can output a clipboard content 302 while saving the specific content in the clipboard memory. In this case, the clipboard content 302 may mean a content saved in the clipboard memory.

According to the example shown in FIG. 3 (b), the outputted clipboard content 302 may include the news content copied and saved in FIG. 3 (a).

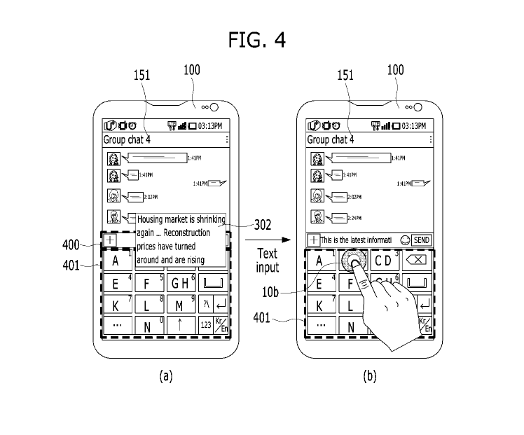

In a step S205, the controller 180 is switched from the web browser application (i.e., a first application) to a message transceiving application (i.e., a second application). The state diagram on the message transceiving application is described in detail with reference to FIG. 4 as follows.

FIG. 4 is a diagram for a control method of easily calling a clipboard region on a running screen of a message transceiving application according to one embodiment of the present invention.

According to one embodiment of the present invention, after a specific content has been copied, if an inter-application switching occurs, it is proposed to output the clipboard content 302 automatically (without a separate command of a user). In particular, after a specific content has been copied and saved in the clipboard, if an inter-application switching occurs, a user may intend to input the specific content to the switched application.

After the specific content has been copied, as shown in FIG. 3, if the controller 180 is switched to the message application, the controller 180 can output the clipboard content 302 onto the message application [S206]. In other words, the controller 180 can control the touchscreen 151 to display the saved content together with a screen associated with a second application (i.e., the message transceiving application), in response to receiving a command to switch from displaying the screen associated with the first application (i.e., the web browser application) to displaying the screen associated with the second application (i.e., the message transceiving application).

And, the controller 180 can output a text input window 400, which is provided to receive an input of a text from a user, onto a running screen of the message application [S207]. A location at which the clipboard content 302 is outputted may include a location adjacent to the text input window 400. In other words, the controller 180 can control the touchscreen 151 to display the saved content in the text input window when the screen associated with the second application includes the text input window.

The controller 180 outputs a virtual keypad 401 (cf. FIG. 4 (a), FIG. 4 (b)) to a prescribed region on the touchscreen 151 and is then able to display a text data on the text input window 400 based on a series of touch inputs applied through the virtual keypad 401.

The controller 180 determines whether the text data is inputted through the outputted text input window 400 [S208]. As a result of the determination, if the text input is not received, the controller 180 goes back to the step S206 and is then able to maintain the output of the clipboard content 302. In other words, the controller 180 can control the touchscreen 151 to maintain the display of the clipboard content 302.

As a result of the determination, if the text input is received, the controller 180 goes to a step S209 and is then able to hide the output of the outputted clipboard content 302. In other words, the controller 180 can control the touchscreen to preclude (or prevent) the display of the saved content when a user inputs text in the text input window. The reason for this is that when a user inputs the text data through the text input window 400, the output of the clipboard content 302 may block a portion of the corresponding screen.

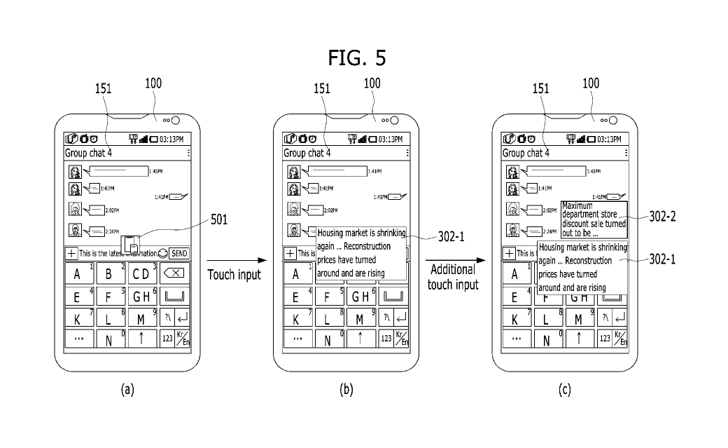

In the embodiment described with reference to FIG. 4, a control method of calling the hidden clipboard content 302 again is described in detail with reference to FIG. 5 by starting with the steps next to the step S209 as follows.

FIG. 5 is a diagram for a control method of calling a clipboard region in case of absence of an input to the text input window 400 for a prescribed time according to one embodiment of the present invention.

Referring to FIG. 5 (a), according to one embodiment of the present invention, if a user's text input fails to be received over a prescribed time [S210], the controller 180 goes to a step S211 and then outputs a clipboard activating icon 501. In other words, if a user stops inputting text for a prescribed period of time, the controller 180 can control the touchscreen 151 to display the clipboard activating icon 501. In particular, if a user stops inputting text for a prescribed period of time, the controller 180 provides the specific content 302 to the user to assist to facilitate a user's content input.

According to another embodiment of the present invention, if the stopped input of the text data is resumed, the controller 180 can control the touchscreen to hide the output of the outputted activating icon 501. In other words, the controller 180 can control the touchscreen 151 to preclude the displayed clipboard activating icon 501 if the user resumes inputting text.

If an input for selecting the clipboard activating icon 501 is received, the controller 180 can re-output a first clipboard content 302-1 hidden in the step S212. One example of the input for selecting the clipboard activating icon 501 may include an input of touching a location at which the clipboard activating icon 501 is displayed.

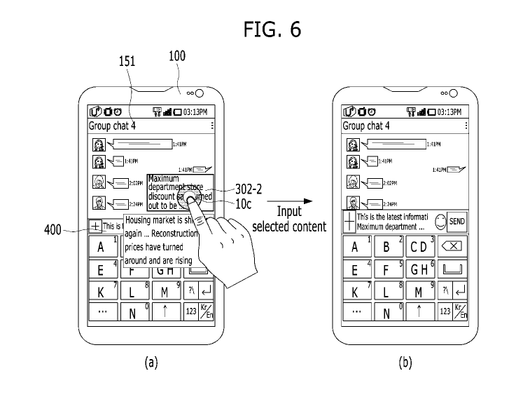

According to another embodiment of the present invention, it is proposed that the controller 180 outputs the clipboard content 302 in response to an input of a prescribed touch gesture. In other words, the controller 180 can control the touchscreen 151 to display the saved content when a first touch gesture associated with the clipboard activating icon 501 is received through the touchscreen 151. For instance, in response to a pinch-in input applied to the touchscreen 151, referring to FIG. 5 (b), the controller 180 can output the first clipboard content 302-1. Moreover, in response to an additional pinch-in input, the controller 180 may be able to further output a second clipboard content 302-2 shown in FIG. 5 (c) in addition to the outputted first clipboard content 302-1. A control method of inputting the clipboard content 302 is described in detail with reference to FIG. 6 as follows.

FIG. 6 is a diagram for a control method of inputting the clipboard content 302 to the text input window 400 according to one embodiment of the present invention.

Referring to FIG. 6 (a), the text input window 400 and the second clipboard content 302-2 are currently outputted through the running screen of the message transceiving application. If an input for selecting the second clipboard content 302-2 is received, referring to FIG. 6 (b), the controller 180 can input the second clipboard content 302-2 to the text input window 400. In this case, the second clipboard content 302-2 includes a text data ‘Full discounts of a department store turned out to be . . . ’, the corresponding text data can be inputted to the text input window 400.

In order to send the second clipboard content 302-2 saved in the clipboard memory to other mobile terminals, the user may input it to the text input window 400.

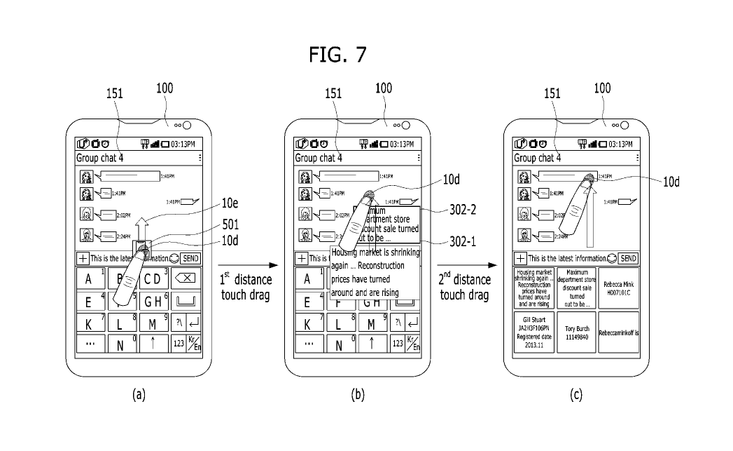

According to the embodiment described with reference to FIG. 5, it is proposed to output the clipboard content 302 in response to the pinch-in input while the clipboard activating icon 501 is displayed. According to one embodiment of the present invention described with reference to FIG. 7, it is proposed to output clipboard contents 302-1, 302-2 . . . in response to a touch-drag input applied to the clipboard activating icon 501.

FIG. 7 is a diagram for a control method of calling a clipboard content saved in a clipboard memory according to one embodiment of the present invention.

Referring to FIG. 7 (a), the controller 180 outputs a running screen of the message transceiving application through the touchscreen. To this running screen, the text input window 400 and the clipboard activating icon 501 can be outputted.

According to one embodiment of the present invention described with reference to FIG. 7, based on a touch drag input applied to the clipboard activating icon 501, it is proposed to output a clipboard content.

If an input of a touch 10d to the clipboard activating icon 501 displayed in FIG. 7 (a) is received and a drag 10e is applied in a prescribed direction over a first distance by holding the touch 10d, the controller 180 can display a first clipboard content 302-1, 302-2 . . . shown in FIG. 7 (b). If the outputted clipboard content is selected, as mentioned in the foregoing description with reference to FIG. 6, the selected clipboard content may be inputted to the text input window 400.

According to one embodiment of the present invention, furthermore, referring to FIG. 7 (c), if a drag 10 is applied over a second distance by holding the touch 10d, it is proposed to output a clipboard region 701. In the clipboard region, a list of at least one or more clipboard contents may be included. Likewise, if an input for selecting the clipboard content included in the list is received, the controller 180 may be able to input the selected clipboard content to the text input window 400.

According to the above-described embodiment, if there is a switching on an application running screen, it is proposed to automatically call a clipboard content saved in a clipboard memory. According to an embodiment mentioned in the following description, if an application list is outputted to switch applications, it is proposed to output a clipboard content.

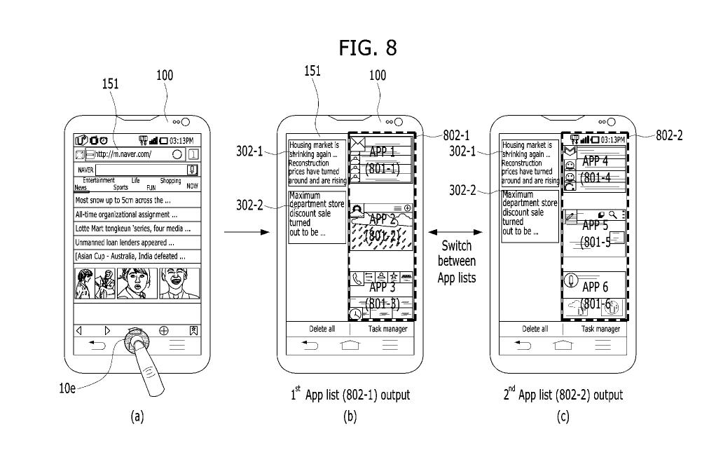

FIG. 8 is a diagram for a control method of outputting a clipboard content if receiving a command for outputting an application list according to one embodiment of the present invention.

Referring to FIG. 8 (a), a running screen of a prescribed application is outputted. If a command for outputting an application list is received through the running screen, referring to FIG. 8 (b), the controller 180 may be able to output a first application list 802-1. In this case, items displayed on the first application list 802-1 may include first to third application items 801-1 to 801-3. For instance, the first to 3d application items 801-1 to 801-3 may include most recently run application items.

According to one embodiment of the present invention, it is proposed to output a clipboard content and an application list at the same time. The reason for this is that a user can input a clipboard content after a switching applications to each other using the application list. Hence, according to one embodiment of the present invention, if the first application list 802-1 is outputted to a prescribed region of the touchscreen, as shown in FIG. 8 (b), the clipboard contents 302-1, 302-2 . . . can be displayed on another region as well.

According to one embodiment of the present invention, referring to FIG. 8 (c), a control method of switching the outputted application lists to each other is further proposed. Based on a function providable through an application, it is able to distinguish an application capable of inputting a content from an application in capable of inputting a content. If a user intends to use a clipboard content, it may be unnecessary for the application incapable of inputting a content to be included in an application list. Hence, if a user intends to use a clipboard content, it is proposed to switch the aforementioned first application list 802-1 to a second application list 802-2. In particular, if the user touches a prescribed one of the clipboard contents 302-1, 302-2 . . . , the controller 180 may be able to switch the first application list 802-1 to the second application list 802-2. In this case, the second application list 802-2 may be configured with an item for an application incapable of inputting a content. As the items included in the second application list 802-2, fourth to sixth application items 801-4 to 801-6 different from the items of the first application list 802-1 are displayed.

An input of a content may mean an input of a prescribed data from a user through such a user input means as a virtual keypad or the like. One example of the application capable of inputting a content may include one of a message transceiving application, a memo application, a calendar application, a contact application and the like. One example of the application incapable of inputting a content may include one of a video play application, a gallery application for viewing photos, and the like.

Alternatively, a list of applications recently using a clipboard may be outputted as the second application list 802-2.

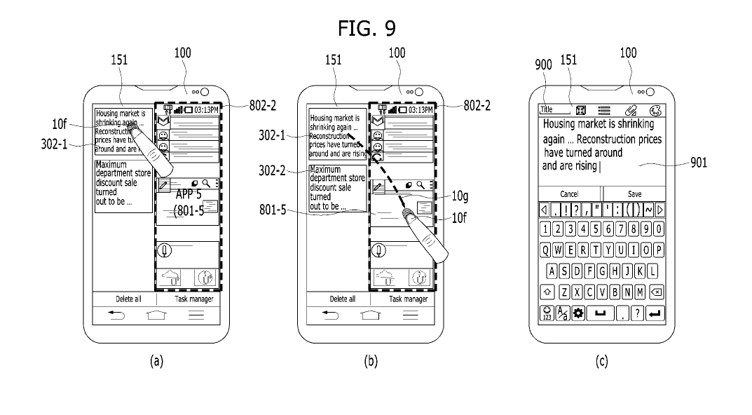

In the following description, a control method of inputting a content easily using an application list and a clipboard content is described in detail with reference to FIG. 9.

FIG. 9 is a diagram for a control method of inputting an outputted clipboard content to an application outputted through an application list according to one embodiment of the present invention.

FIG. 9 (a) is a state diagram of outputting the second application list 802-2 together with the first clipboard content 302-1 like the former embodiment described with reference to FIG. 8.

According to one embodiment of the present invention, after the first clipboard content 302-1 has been selected, if an input for selecting a specific application item from the second application list 802-2 is received, it is proposed to input the first clipboard content 302-1 to an application corresponding to the selected specific application item.

In particular, referring to FIG. 9 (a) and FIG. 9 (b), one example of the input for selecting the specific application item from the second application list 802-2 after selecting the first clipboard content 302-1 may include a touch gesture of applying a touch 10f to the first clipboard content 302-1 and then applying a drag 10g to a specific application item 801-5. After the first clipboard content 302-1 has been inputted to the application, as shown in FIG. 9 (c), the controller 180 can output a running screen 900 of the application including the inputted first clipboard content 302-1. Referring to FIG. 9 (c), it can be observed that the first clipboard content copied and saved in the clipboard memory according to the aforementioned embodiment is currently displayed.

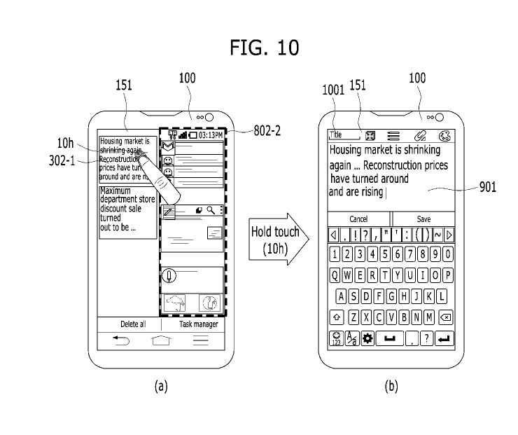

Meanwhile, according to the above embodiment, a specific application to which a content will be inputted is selected from a list. Unlike this, in case of intending to input a content to a most recently run application, it may be unnecessary to select the content from the list. Such an embodiment is described in detail with reference to FIG. 10 as follows.

FIG. 10 is a diagram for a control method of inputting a clipboard content to a most recently run application according to one embodiment of the present invention.

Referring to FIG. 10 (a), like the aforementioned embodiment, the controller 180 currently outputs the first clipboard content 302 and the second application list 802-2 at the same time. According to one embodiment of the present invention described with reference to FIG. 10, since it is intended to input a content to a most recently run application, a selection of a clipboard content is necessary only.

Hence, if an input for selecting a clipboard content is received, the controller 180 may be able to input the selected clipboard content to a most recently run application. In other words, the controller can control the touchscreen 151 to display content saved in the clipboard memory and to input the selected content to a most recently run application in response to a selection of content from the displayed content. In this case, the most recently run application is taken as one example, by which the present embodiment is non-limited. For instance, the present embodiment may be applicable to an application of most frequently inputting contents using a clipboard or a specific application previously set by a user.

According to the embodiment related to FIG. 10, one example of the input for selecting the clipboard content may include an input of applying a touch 10h to an outputted clipboard content and then holding it over a prescribed time.

On the other hand, according to another embodiment of the present invention, it is proposed to extend types of contents that can be inputted using a clipboard. For instance, it is proposed to manage a content downloaded through the wireless communication 110 or the like or a content containing numeral data using a clipboard as well as a content selected and copied by a user. Such an embodiment is described in detail with reference to the accompanying drawing as follows.

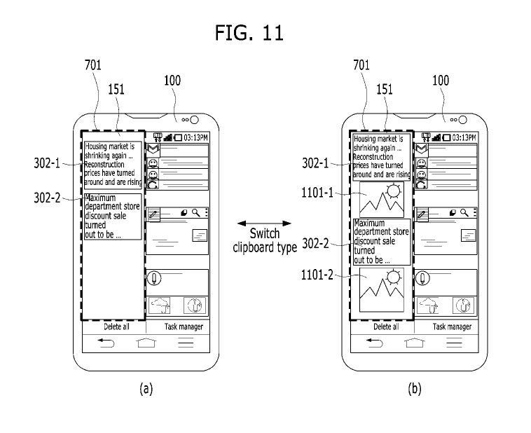

FIG. 11 is a diagram for a control method of managing an extended content using a clipboard according to one embodiment of the present invention.

Referring to FIG. 11 (a), the controller 180 outputs clipboard contents 302-1, 302-2 . . . to a clipboard region 701 together with an application list 802 through the touchscreen 151. Referring to FIG. 11 (b), if a command for switching a clipboard type is received, the controller 180 can further output download contents 1101-1, 1101-2 . . . to the clipboard region 701. One example of the switching command may include a command of scrolling the clipboard region 701. In particular, the switching command may include a command of applying a touch to the clipboard region 701 and then applying a drag in a top direction.

Moreover, according to one embodiment of the present invention, it is proposed to differentiate a preferentially display content based on a function performed prior to calling the clipboard region 701. For instance, if a download is completed prior to calling the clipboard region 701, a download content may be preferentially displayed on the clipboard region 701 outputted in response to a user's clipboard call command (e.g., displayed in a manner of being aligned on a top side).

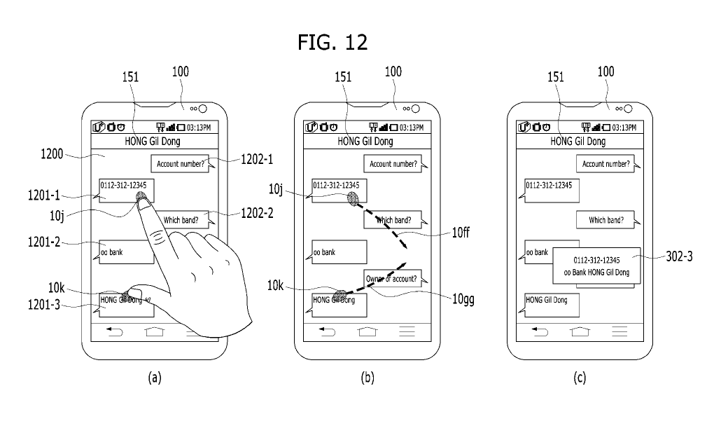

Meanwhile, according to one embodiment of the present invention, in copying and saving a content in a clipboard memory, it is intended to propose a control method of copying a unit of a plurality of contents at a time or collectively. Such an embodiment is described in detail with reference to FIG. 12 as follows.

FIG. 12 is a diagram for a control method of copying a plurality of content items collectively and then saving the copied items according to one embodiment of the present invention.

Referring to FIG. 12 (a), a running screen 1200 of a message application is currently outputted. On the message application, sent messages 1202-1, 1202-2 . . . inputted and sent to another mobile terminal by a user and received messages 1201-1, 1201-2, 1201-3 . . . received from another mobile terminal can be displayed.

As each of the displayed messages is handled as an individual item, assume that a single message item can be saved in response to a single copy command.

According to one embodiment of the present invention, proposed is a control method of collectively copying a plurality of message items based on a touch gesture input.

Referring to FIG. 12 (b), if a touch 10j to the first received message 1201-1 and a touch 10k to the third received message 1201-3 are detected at the same time and a touch gesture of pinching in by moving in a prescribed direction (e.g., a right direction) is detected, the controller 180 can collectively save the first to third received messages 1201-1 to 1201-3. According to the example shown in the drawing, when the first to third received messages 1201-1 to 1201-3 are ‘0112-312-12345’, ‘oo Bank’ and ‘HONG Gil Dong’, respectively, referring to FIG. 12 (c), a copied clipboard content 302-3 may include all the contents (i.e., ‘0112-312-12345, oo Bank, HONG Gil Dong’) included in the received messages, respectively.

Meanwhile, the present embodiment is non-limited by the above example of the touch gesture and may be further applicable to any touch gestures capable of designating a plurality of message items.

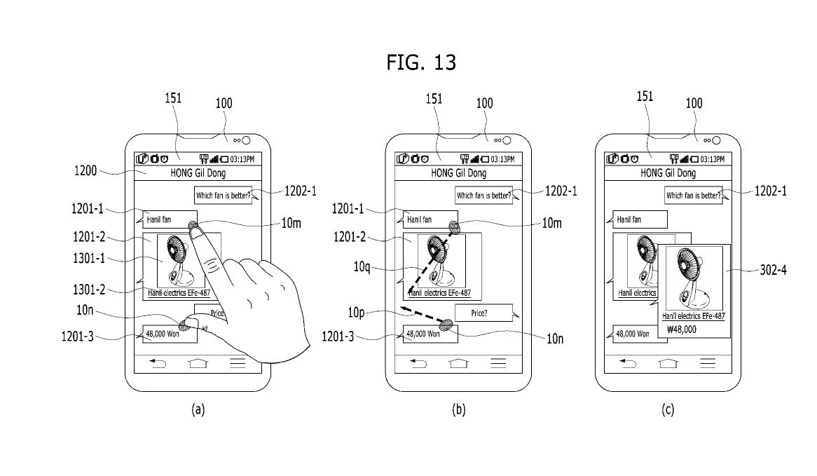

According to the above-described embodiment, a control method of collectively saving text contents is described. In the following description, a control method of collectively saving complex contents together with a text content is described with reference to FIG. 13.

FIG. 13 is a diagram for a control method of collectively saving an image content and a URL (uniform resource locator) content together with a text content according to one embodiment of the present invention.

Referring to FIG. 13 (a), the controller 180 outputs a running screen 1200 of a message transceiving application.

On the message application, sent messages 1202-1, 1202-2 . . . inputted and sent to another mobile terminal by a user and received messages 1201-1, 1201-2, 1201-3 . . . received from another mobile terminal can be displayed. According to the example shown in the drawing, the first received message 1201-1 includes ‘Hanil Fan’, the second received message includes an image 1301-1 and a hyperlink text 1301-2 having a prescribed URL information linked thereto, and the third received message 1201-3 includes ‘48,000 Won’.

Referring to FIG. 13 (b), if a touch 10m to the first received message 1201-1 and a touch 10n to the third received message 1201-3 are detected at the same time and a touch gesture of pinching in by moving in a prescribed direction (e.g., a left direction) is detected, the controller 180 can collectively save a text content, an image content and a URL content included in the first to third received messages 1201-1 to 1201-3. Referring to FIG. 13 (c), the contents of the Hanil fan, the image, the ULR information linked hyperlink text and the 48,000 Won may be collectively saved as a clipboard content 302-4.

Meanwhile, the present embodiment is non-limited by the above example of the touch gesture and may be further applicable to any touch gestures capable of designating a plurality of message items.

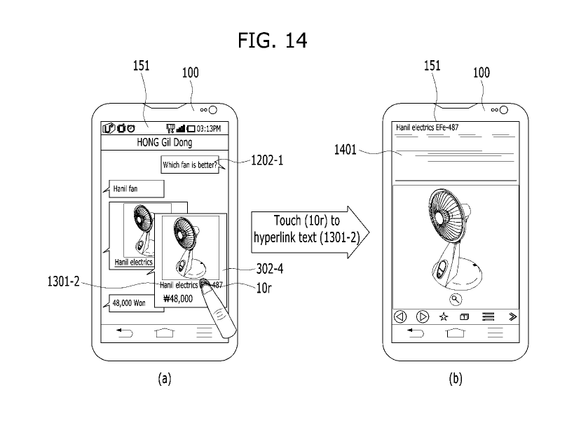

FIG. 14 is a diagram for a control method for a case that the above-mentioned hyperlink text is selected of according to one embodiment of the present invention.

Referring to FIG. 14, if an input 10r for selecting the hyperlink text 1301-2 displayed on the clipboard content 302-4 is received [FIG. 14 (a)], the controller 180 runs a web browser, calls a webpage based on a URL content included in the hyperlink text 1301-2, and is then able to output the called webpage [FIG. 14 (b)].

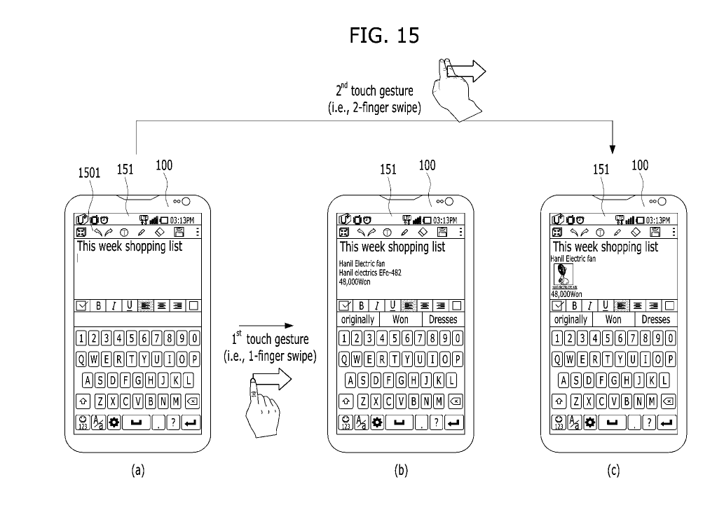

As mentioned in the foregoing description, according to one embodiment of the present invention, a copy operation can be performed on a complex content. Thus, if the complex content is copied, according to one embodiment of the present invention, it is proposed to apply an input in a different way using a distinguished gesture. Such an embodiment is described in detail with reference to FIG. 15 as follows.

FIG. 15 is a diagram for a control method of distinguishing a scheme for inputting a complex content according to one embodiment of the present invention.

Referring to FIG. 15 (a), the controller 180 currently outputs a running screen 1501 of a memo application through the touchscreen 151. On the running screen 1501 of the memo application, a user's text data can be inputted using a virtual keypad or the like. And, a clipboard content may be inputted to the running screen 1501 of the memo application through a paste command for the clipboard content.

In describing the embodiment shown in FIG. 15, assume that the complex content described with reference to FIG. 13 is saved as the clipboard content 302-4.

If a first touch gesture is received, the controller 180 switches a type of the complex content to a text type and is then able to input the corresponding content to the memo application [FIG. 15 (b)]. If a second touch gesture is received, the controller 180 does not switch the type of the complex content to the text type but is able to input the corresponding content to the memo application [FIG. 15 (c)]. One example of the first touch gesture may include a swipe input with a single finger. One example of the second touch gesture may include a swipe input with two fingers.

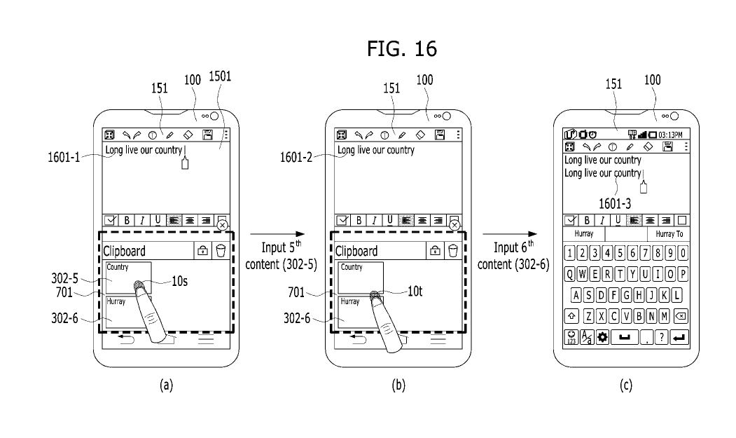

Meanwhile, according to one embodiment of the present invention, if an unused content exists in the contents saved in the clipboard memory, it is proposed to keep holding an output of the clipboard region 701. Such an embodiment is described in detail with reference to FIG. 16 as follows.

FIG. 16 is a diagram for a control method of when a plurality of contents are saved in a clipboard memory, if an unused content exists, controlling an output of the clipboard region 70 to be maintained instead of disappearing according to one embodiment of the present invention.

First of all, according to an embodiment described with reference to FIG. 16, if a content saved in the clipboard memory is used, assume that the outputted clipboard region 701 disappears. Yet, if an unused content exists in the clipboard memory, the controller 180 controls the output of the clipboard region 701 to be maintained until the unused content is used.

Assume that a fifth clipboard content 302-5 and a sixth clipboard content 302-6 are saved in the clipboard memory.

Referring to FIG. 16 (a), the controller 180 currently outputs a running screen 1501 of a memo application through the touchscreen 151. And, a previously inputted text content 1601-1 is displayed on the running screen 1501 of the memo application. If the fifth clipboard content 302-5 is selected, the controller 180 can additionally input the fifth clipboard content 302-5 together with the previously inputted text content 1601-1.

If the sixth clipboard content 302-6 is not inputted yet, the controller 180 can maintain the output of the clipboard region 701 [FIG. 16 (b)]. Subsequently, if an input 10t for selecting the sixth clipboard content 302-6 is received, the controller 180 can input the sixth clipboard content 302-6 to the memo application.

In case that a content saved in the clipboard memory is used (or inputted) at least once, the controller 180 can control the automatically outputted clipboard region 701 not to be outputted any more. And, the controller 180 can output a virtual keypad to a location to which the clipboard region 701 was outputted [FIG. 16 (c)].

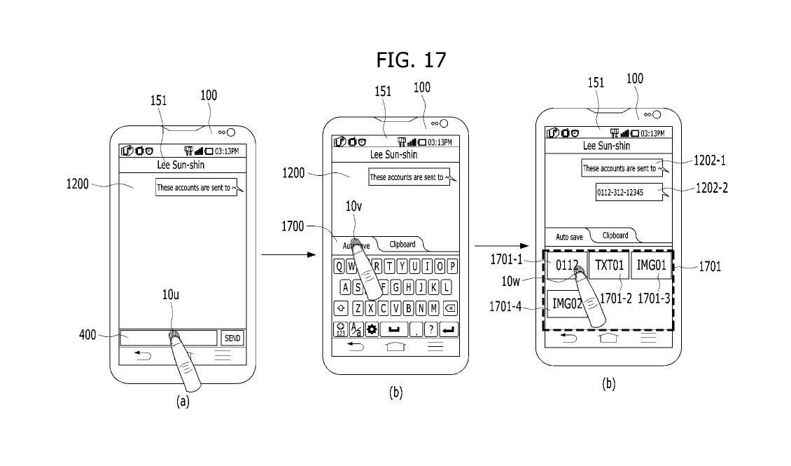

Meanwhile, according to one embodiment of the present invention, further proposed is a control method of determining a significant information automatically and managing the determined significant information by automatically saving the determined significant information without a user's saving command. Such an embodiment is described in detail with reference to FIG. 17 as follows.

FIG. 17 is a diagram for a control method of determining an information difficult to be memorized by a user and then saving the corresponding information automatically without a user's command according to one embodiment of the present invention.

Generally, regarding a human memory, it is difficult to memorize irregular information. Although the irregular information is memorized, it is difficult to be held for a long time. Hence, it may be difficult to memorize an irregular enumeration of numerals such as a phone number, an account number and the like. According to one embodiment of the present invention, it is proposed to detect numerals enumerated more than a prescribed number, to save the enumeration of the corresponding numerals automatically, and to provide the detected numerals to a user.

Referring to FIG. 17 (a), a running screen 1200 of a message application is currently outputted. And, a text input window 400 for receiving an input of text data from a user is outputted.

If an input 10u for selecting the text input window 400 is received, the controller 180 outputs a virtual keypad and is also able to output a tab ‘auto save’ capable of inputting an automatically saved information/content to the content input window 400, simultaneously.

Referring to FIG. 17 (b), if an input 10v for selecting the tab ‘auto save’ 1700 is received, the controller 180 can output a clipboard ‘auto save’ 1701 displaying a list of automatically saved contents. As mentioned in the foregoing description, auto saved contents 1701-1, 1701-2 . . . , which are automatically saved, can be outputted to the clipboard ‘auto save’ 1701. If a selection 10w of the first auto saved content 1701-1 is received, the controller 180 can apply an input 1202-2 of the selected first auto saved content 1701-1 to the text input window 400 [FIG. 17 (c)].

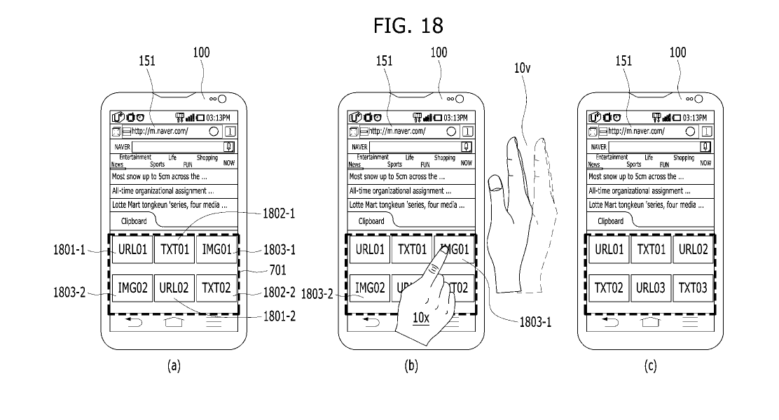

Meanwhile, according to one embodiment of the present invention, further proposed is a control method of efficiently managing contents saved in a clipboard memory. Such an embodiment is described in detail with reference to FIG. 18 as follows.

FIG. 18 is a diagram for a control method of efficiently deleting and managing a content saved in a clipboard memory according to one embodiment of the present invention.

Referring to FIG. 18 (a), a clipboard region 701 is outputted together with a running screen of a prescribed application. In the clipboard region 701, clipboard contents of various types can be included. In this case, the various types may include text type contents 1802-1, 1802-2 . . . , URL type contents 1801-1, 1801-2 . . . , and image type contents 1803-1, 1803-2 . . . .

After a prescribed content has been selected, if a delete command is received, it is proposed to collectively delete contents of the same type of the selected content.

After a selection 10x of the first image type content 1803-1 has been selected, if an input 10y of tapping a body of the mobile terminal 100 is received [FIG. 18 (b)], the controller 180 can collectively delete the contents of the image type from the clipboard memory [FIG. 18 (c)].

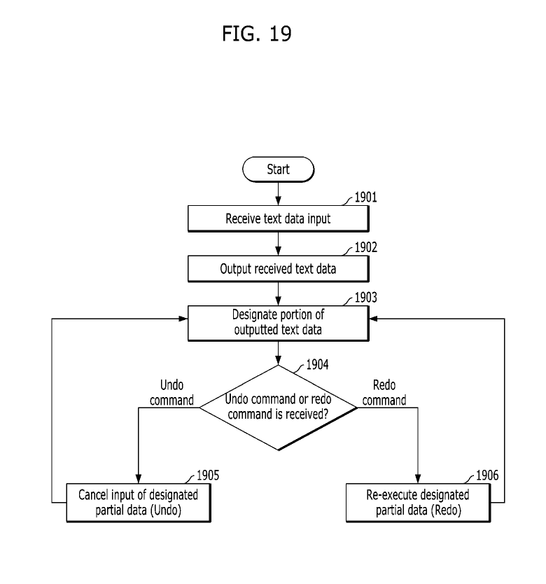

Meanwhile, according to one embodiment of the present invention, it is intended to further propose a control method of editing an inputted text data easily. Such an embodiment is described in detail with reference to FIG. 19 as follows.

FIG. 19 is a diagram for a control method of easily editing a previously inputted text data according to one embodiment of the present invention.

Generally, as functions executable in a document composing application or software, there are an input cancellation function (i.e., an undo function) and a re-execute function (i.e., a redo function). The undo function means a function of returning a data inputted by a user to a pre-input state. The redo function means a function of restoring into a pre-return state from a returned state by the undo. Such a function can be launched at least once depending on the inputted number of a user's command. For instance, if an undo command is inputted plural times, the undo function can be launched as many times as the corresponding count of the inputs.

According to one embodiment of the present invention mentioned in the following description, in performing the undo function and the redo function, proposed are: 1) a method of designating a region for performing a function; 2) a method of performing the undo function and the redo function on the designated region only; and 3) a control method of easily inputting a command plural times.

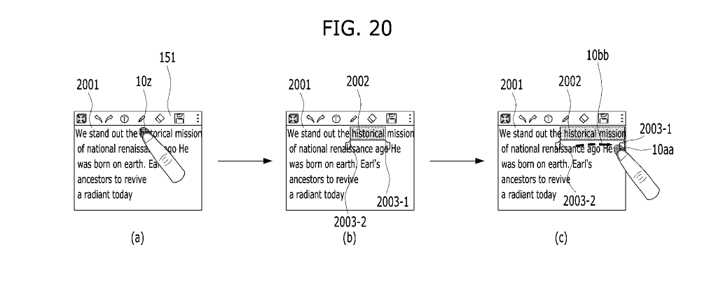

A flowchart shown in FIG. 19 is described in detail with reference to FIGS. 20 to 25 as follows.

Referring to FIG. 19, in a step S1901, the controller 180 receives a text data input from a user. Such a text data input may be received through a virtual keypad outputted through the touchscreen 151. Referring to FIG. 20 (a), a running screen 2001 of a memo application is currently outputted. And, a text data inputted by a user is outputted to the running screen 2001 [S1902].

If a portion of the outputted text data is designated [S1903], the controller 180 goes to a step S1904 and is then able to receive a selection indicating whether to undo or redo the designated portion. The portion designating step S1903 is described in detail with reference to FIGS. 20 to 22 as follows.

FIGS. 20 to 22 are diagrams for a control method of designating a portion of a text inputted by a user according to one embodiment of the present invention.

Referring to FIG. 20 (a), a text data inputted by a user is outputted to a running screen 2001 of a memo application. If a touch 10z to a prescribed word on the outputted text data is received, the controller 180 can designate the corresponding word. In doing so, in order to indicate that the corresponding word is designated, a designation indicator 2002 may be further outputted to the designated region.

Referring to FIG. 20 (a), FIG. 20 (b) and FIG. 20 (c), adjustment indicators 2003-1 and 2003-2 for adjusting the designated region can be further outputted to both ends of the designated region, respectively. If a touch 10aa and drag 10bb are applied to the first adjustment indicator 2003-1, it is able to designate the text data located between the adjustment indicators 2003-1 and 2003-2. In particular, if the user touches a specific word, the corresponding word can be designated. And, a designated region can be enlarged/reduced through adjustments of the adjustment indicators after the designation.

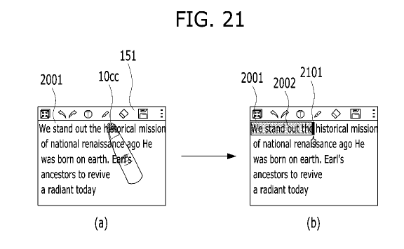

Referring to FIG. 21 (a) and FIG. 21 (b), if an input of a touch 10cc to a prescribed point on an outputted text data is received, the controller 180 locates a cursor 2101 at the prescribed point and is then able to designate the text data between a start point of the text data and the touched prescribed point. In doing so, a designation indicator 2002 can be further outputted for the designated region.

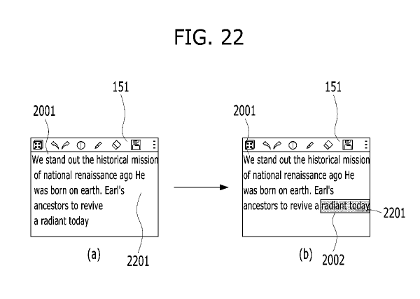

In FIG. 22 (a) and FIG. 22 (b), it is proposed to designate a region through an input of a specific text data. Referring to FIG. 22 (a), the controller 180 receives a typing input of a specific text data (e.g., ‘ . . . ’) 2201 from a user. If the specific text data 2201 is inputted, the controller 180 can designate a text data of a region adjacent to the specific data 2201. Referring to FIG. 22 (b), the controller 180 designates a word existing on a most left side of the specific data 2201 and then outputs a designation indicator 2202 to the designated word.

The designating methods according to the embodiments described with reference to FIGS. 20 to 22 are just exemplary, by which one embodiment of the present invention is non-limited.

Referring now to FIG. 19, in a step S1904, the controller 180 receives an undo command or a redo command.

If the undo command is received from the user, the controller 180 goes to a step S1905 and is then able to execute an undo function on the designated partial data. If the redo command is received from the user, the controller 180 goes to a step S1906 and is then able to execute the redo function on the designated partial data.

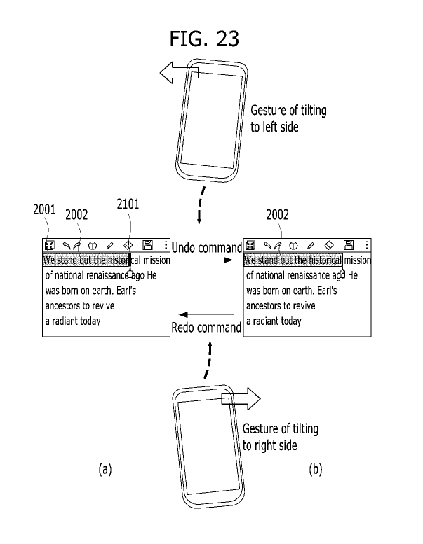

Examples of distinguishing a command received from a user as an undo command or a redo command are described in detail with reference to FIGS. 23 to 25 as follows.

FIGS. 23 to 25 are diagrams for a control method of distinguishing an undo/redo command according to one embodiment of the present invention.

Referring to FIG. 23 (a) and FIG. 23 (b), a text data ‘We stand out the historical’ is designated on a running screen 2001 of a memo application. If a gesture of tilting the mobile terminal 100 to a left side is received, the controller 180 can execute an undo function on the designated text data [switching to FIG. 23 (b) from FIG. 23 (a)]. In particular, the gesture of tilting to the left side is the undo command.

Likewise, if a gesture of tilting the mobile terminal 100 to a right side is received, the controller 180 can execute a redo function on the designated text data [switching to FIG. 23 (a) from FIG. 23 (b)]. In particular, the gesture of tilting to the left side is the undo command.

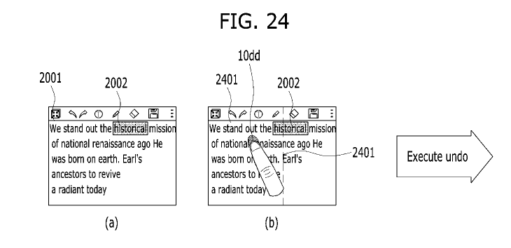

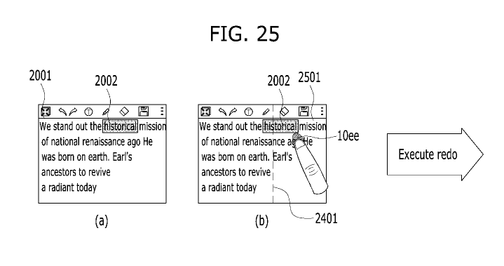

Besides the tilting action described with reference to FIG. 23, it may be able to distinguish the command by dividing the touchscreen 151 into regions and then determining that a touched point belongs to which region. Such an embodiment is described in detail with reference to FIG. 24 and FIG. 25 as follows.

Referring to FIG. 24 and FIG. 25, a text data ‘historical’ is designated on a running screen 2001 of a memo application. If an input of a touch 10dd to a first region 2401 among regions divided on a basis of a prescribed reference 2401 is received [FIG. 24 (a), (b)], the controller 180 can execute an undo function.

If an input of a touch 10ee to a second region 2501 among regions divided on a basis of a prescribed reference 2401 is received [FIG. 25 (a), (b)], the controller 180 can execute a redo function.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

### INDUSTRIAL APPLICABILITY

The present invention relates to a mobile terminal and a method for controlling the same. Therefore, the present invention has industrial applicability.

What is claimed is:

1. A mobile terminal comprising:
a touchscreen;
a clipboard memory; and
a controller configured to:
control the touchscreen to display a screen associated with a first application,
save, in the clipboard memory, content designated by a user displayed on the screen associated with the first application, and
control the touchscreen to display the saved content together with a screen associated with a second application, in response to receiving a command to switch from displaying the screen associated with the first application to displaying the screen associated with the second application.

2. The mobile terminal of claim 1, wherein the screen associated with the second application includes a text input window and wherein the controller is further configured to control the touchscreen to display the saved content in the text input window.

3. The mobile terminal of claim 2, wherein the controller is further configured to control the touchscreen to preclude the display of the saved content when a user inputs text in the text input window.

4. The mobile terminal of claim 3, wherein the controller is further configured to control the touchscreen to display a clipboard activating icon if the user stops inputting text for a prescribed period of time.

5. The mobile terminal of claim 4, wherein the controller is further configured to control the touchscreen to preclude the displayed clipboard activating icon if the user resumes inputting text.

6. The mobile terminal of claim 4, wherein the controller is further configured to control the touchscreen to display the saved content when a first touch gesture associated with the clipboard activating icon is received through the touchscreen.

7. The mobile terminal of claim 6, wherein the controller is further configured to control the touchscreen to display a list of content saved in the clipboard memory when a second touch gesture associated with the clipboard activating icon is received through the touchscreen.

8. The mobile terminal of claim 1, wherein the controller is further configured to control the touchscreen to display content saved in the clipboard memory and, at the same time, display an application list.

9. The mobile terminal of claim 8, wherein the controller, in response to a selection of content from the displayed content and a selection of an application from the displayed application list, is further configured to input the selected content to the selected application.

10. The mobile terminal of claim 1, wherein the controller is further configured to control the touchscreen to display content saved in the clipboard memory and configured, in response to a selection of content from the displayed content, to input the selected content to a most recently run application.

11. A method of controlling a mobile terminal that includes a touchscreen, the method comprising:
displaying a screen associated with a first application;
saving, in a clipboard memory, content designated by a user displayed on the screen associated with the first application; and
displaying the saved first content together with a screen associated with a second application, in response to receiving a command to switch from displaying the screen associated with the first application to displaying the screen associated with the second application.

12. The method of claim 11, wherein the screen associated with the second application includes a text input window and wherein the method further comprises displaying the saved content in the text input window.

13. The method of claim 12 further comprising:
hiding the saved content when a user inputs text in the text input window.

14. The method of claim 13, further comprising:
displaying a clipboard activating icon if the user stops inputting text for a prescribed period of time.

15. The method of claim 14 further comprising:
hiding the displayed activating icon if the user resumes inputting text.

16. The method of claim 14 further comprising:
displaying the saved content when a first touch gesture associated with the clipboard activating icon is received through the touchscreen.

17. The method of claim 16 further comprising:
displaying a list of content saved in the clipboard memory when a second touch gesture associated with the clipboard activating icon is received through the touchscreen.

18. The method of claim 11 further comprising:
displaying the content saved in the clipboard memory and, at the same time, displaying an application list.

19. The method of claim 18 further comprising:
detecting a selection of an application from the displayed application list and a selection of content from the displayed content, and
inputting the selected content to the selected specific application.

20. The method of claim 11 further comprising:
displaying content saved in the clipboard memory;
detecting a selection of content from the displayed content; and
inputting the selected content to a most recently run application.
